(19) United States
(12) Patent Application Publication
(10) Pub. No.: US 2024/0265374 A1
(43) Pub. Date: Aug. 8, 2024

(54) Method For Providing Decentralized Wallet Service, Apparatus For Performing The Method, And Storage Medium For Storing Program To Execute The Method

(71) Applicant: Com2uS Platform Corporation, Seoul (KR)

(72) Inventors: Hwanhee Lee, Siheung (KR); Seongyeon Lee, Siheung (KR); Jihyun Won, Seoul (KR)

(21) Appl. No.: 18/495,304

(22) Filed: Oct. 26, 2023

(30) Foreign Application Priority Data
Feb. 7, 2023 (KR) 10-2023-0015955

(51) Int. Cl. G06Q 20/36

(52) U.S. Cl. CPC G06Q 20/3678

(57) ABSTRACT

According to the present disclosure, by storing encrypted wallet-specific information using a wallet password, extortion of a private key or mnemonic in a conventional decentralized wallet is prevented, thereby enhancing security, by providing a wallet service account capable of identity provider (IdP) login, general users who are not familiar with a blockchain are also allowed to conveniently open and manage a wallet, thereby enhancing usability, and by providing a decentralized integrated wallet service through the web browser type wallet service client, the user is allowed to use the wallet service at any time without installing a separate program, thereby enhancing convenience. The techniques described herein also increase security of a wallet.

### CROSS-REFERENCE TO RELATED APPLICATION(S)

This application claims benefit and priority to Korean Patent Application No. 10-2023-0015955, filed on Feb. 7, 2023, with the Korean Intellectual Property Office, the disclosure of which is incorporated herein in its entirety by reference.

### TECHNICAL FIELD

The present disclosure relates to a method for providing a decentralized wallet service, an apparatus for performing the method, and a storage medium for storing a program to execute the method, and more particularly, to a method, an apparatus, and a storage medium for providing a wallet service.

### BACKGROUND

Wallets are required for users to use the cryptocurrency, the Non-Fungible token (NFT), etc., of a blockchain network, and there are various technologies in a method for opening and implementing the wallets. A blockchain wallet includes a centralized wallet that can be controlled and can store a mnemonic password or private key of the user, and conduct signing instead of the user, and a decentralized wallet that cannot be controlled, in which the user keeps the mnemonic password or private key and personally conducts signing.

As a general example, the decentralized wallet of the structure through a separate installation program is universal through the configuration of a client app, which is called hot wallet. The hot wallet refers to all wallets that are connected online. Therefore, the hot wallet can be used conveniently in real time but has a problem that the hot wallet is likely to be exposed to security risks and hacking. Hackers can extort the user's private keys and mnemonic by attacking the hot wallet of which real-time transaction is made in a network connection state. The reason for the universal use is that the blockchain network wallet provides transparent histories of transactions, creating trust with users. A transaction hash (TX HASH) is left for every transaction, and a transaction ID (TXID) that is generated herein is stored in the blockchain in order to check an input and an output of the corresponding transaction, so the transaction cannot be modified or deleted.

However, users who are new to the blockchain can be unfamiliar with a wallet opening method and have a problem that they cannot use the wallet itself after losing the mnemonic password or private key, and may not fully know even a method of reading the transaction history and the transaction (Tx) hash value. The mnemonic refers to 12 to 24 words for recovering the wallet. Because the private key is constituted by too complex words, the mnemonic is a format that enables the private key to be easily input. When the mnemonic and the private key are lost, if the mnemonic and the private key are not kept by an individual, the wallet cannot be used. Even though the mnemonic and the private key are hacked, the user should be responsible for the hacking, which may give security anxiety to the user.

On the other hand, there is the centralized wallet, which is not universal, but allows the user to easily use the blockchain wallet. In the case of the centralized wallet, a provider server conducts keeping of the mnemonic password for the user and proxy signature, so the user can easily use the service. However, the user cannot control the wallet as much, and cannot personally conduct mnemonic password keeping or the signature, or manage the wallet. In addition, if an identity provider (IdP) login scheme is added to the centralized wallet, easy login is possible. For example, easy login to Google, Facebook, etc., is possible with an IdP account used by most users. However, because each provider server (IdP login service provider) keeps the password, the security is lowered, and even if the security is strengthened in the IdP login, the wallet or blockchain being hacked is a separate problem, so the user cannot take an action and perform a direct manipulation.

In the case of the decentralized wallet and the centralized wallet, the wallets can be usually used only in one mainnet or fixed blockchain ecosystem, so there is a hassle of managing a plurality of wallets for each mainnet (chain).

### SUMMARY

The present disclosure has been made in an effort to provide a method for providing a decentralized wallet service, an apparatus for performing the method, and a storage medium for storing a program to execute the method, which store encrypted wallet-specific information by using a wallet password.

The present disclosure has also been made in an effort to provide a method for providing a decentralized wallet service, an apparatus for performing the method, and a storage medium for storing a program to execute the method, which provide a wallet service account capable of identity provider (IdP) login.

The present disclosure has also been made in an effort to provide a method for providing decentralized wallet service, an apparatus for performing the method, and a storage medium for storing a program to execute the method, which provide a decentralized integrated wallet service through a web-browser type wallet service client.

Other objects of the present disclosure, which are not explicitly described, may be additionally considered within the scope that can be easily deduced from the following detailed description and the effects thereof.

An embodiment of the present disclosure provides a method for providing a decentralized wallet service, which includes receiving, from a user terminal, wallet specific information encrypted by using a wallet password input when a wallet is created by a user, and storing the wallet specific information encrypted by using the wallet password, in which the wallet specific information encrypted by using the wallet password is not stored in the user terminal.

The user terminal may be a web browser type wallet service client executed by the user terminal.

The method may further include logging in to a wallet service account of the user through identity provider (IdP) log by a manipulation of the user, and in the receiving of the wallet specific information, the wallet specific information encrypted by using the wallet password input by the user who logs in to the wallet service account may be received from the web browser type wallet service client.

The method may further include when a signature target message according to a wallet service is received from the web browser type wallet service client, performing the signature by using the stored encrypted wallet specific information.

The performing of the signature may include when the signature target message is received from the web browser type wallet service client, storing the received signature target message, when a wallet information request is received from the web browser type wallet service client, transmitting the stored encrypted wallet specific information and the stored signature target message to the web browser type wallet service client, and receiving, from the web browser type wallet service client, the signature target message signed based on the wallet specific information decrypted from the wallet specific information encrypted by using the wallet password input when performing the signature by the user.

In the storing of the signature target message, the received signature target message may be stored, and a one-time transaction key is transmitted to the web browser type wallet service client. In the transmitting of the encrypted wallet specific information, the encrypted wallet specific information may be re-encrypted by using the one-time transaction key, and the re-encrypted wallet specific information and the signature target message may be transmitted to the web browser type wallet service client. In the receiving of the signed signature target message, the re-encrypted wallet specific information may be decrypted by using the one-time transaction key, and then the signature target message signed based on the wallet specific information decrypted from the wallet specific information encrypted by using the wallet password input may be received from the web browser type wallet service client when performing the signature by the user.

The signature target message may be a transaction message created by the web browser type wallet service client.

The method may further include when a connection request of an external wallet is received from the web browser type wallet service client, connecting the external wallet to the wallet service account.

The connecting of the external wallet may include receiving the encrypted wallet specific information of the external wallet by using the wallet password input when connecting the external wallet by the user from the web browser type wallet service client and storing the encrypted wallet specific information of the external wallet. The encrypted wallet specific information of the external wallet may not be stored in the web browser type wallet service client.

The method may further include when a login request of a blockchain-based external service is received from a blockchain-based external service providing server, performing the login of the blockchain-based external service by using a wallet selected by the user among the wallets connected to the wallet service account.

The method may further include when a signature target message according to an external service is received from the blockchain-based external service providing server, performing the signature by using the stored encrypted wallet specific information.

The performing of the signature may include when the signature target message is received from the blockchain-based external service providing server, storing the received signature target message, when a wallet information request is received from the web browser type external service client executed by the user terminal through the web browser type wallet service client, transmitting the stored encrypted wallet specific information and the stored signature target message to the web browser type wallet service client, and receiving, from the web browser type wallet service client, the signature target message signed based on the wallet specific information decrypted from the wallet specific information encrypted by using the wallet password input when performing the signature by the user.

In the storing of the signature target message, the received signature target message may be stored, and the one-time transaction key may be transmitted to the blockchain-based external service providing server. In the transmitting of the encrypted wallet specific information, the encrypted wallet specific information may be re-encrypted by using the one-time transaction key, and the re-encrypted wallet specific information and the signature target message may be transmitted to the web browser type wallet service client. In the receiving of the signed signature target message, the re-encrypted wallet specific information may be decrypted by using the one-time transaction key provided from the web browser type external service client, and then the signature target message signed based on the wallet specific information decrypted from the wallet specific information encrypted by using the wallet password input may be received from the web browser type wallet service client when performing the signature by the user.

The signature target message may be a transaction message created by the web browser type external service client.

The wallet password may be set to correspond to the wallet service account by the user to be used for all of the wallets connected to the wallet service account, or set for each wallet by the user.

The wallet specific information may be a private key or mnemonic.

Another embodiment of the present disclosure provides a computer-readable storage medium having a program for executing the method for providing a decentralized wallet service, which is recorded therein.

Still another embodiment of the present disclosure provides an apparatus for providing a decentralized wallet service that includes a memory storing one or more programs for providing a decentralized wallet service and one or more processors performing an operation for providing the decentralized wallet service according to the one or more programs stored in the memory. The processor receives, from a user terminal, wallet specific information encrypted by using a wallet password input when creating a wallet by a user and stores the wallet specific information encrypted by using the wallet password. The wallet specific information encrypted by using the wallet password is not stored in the user terminal.

The user terminal may be a web browser type wallet service client executed by the user terminal.

The processor may log in to a wallet service account of the user through identity provider (IdP) log by a manipulation of the user and receive the wallet specific information encrypted by using the wallet password input by the user who logs in to the wallet service account from the web browser type wallet service client.

According to embodiments of the present disclosure, in a method for providing a decentralized wallet service, an apparatus for performing the method, and a storage medium for storing a program to execute the method, by storing encrypted wallet-specific information using a wallet password, extortion of a private key or mnemonic in a conventional decentralized wallet is prevented, thereby enhancing security.

By providing a wallet service account capable of identity provider (IdP) login, general users who are not familiar with a blockchain are also allowed to conveniently open and manage a wallet, thereby enhancing usability.

By providing a decentralized integrated wallet service through the web browser type wallet service client, the user is allowed to use the wallet service at any time without installing a separate program, thereby enhancing convenience.

The embodiments of the present disclosure are not limited to the aforementioned embodiments, and other embodiments, which are not mentioned above, will be apparent to a person having ordinary skill in the art from the following disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram for describing a system for providing a decentralized wallet service according to an embodiment of the present disclosure.

FIG. 2 is a block diagram for describing an apparatus for providing the decentralized wallet service illustrated in FIG. 1.

FIG. 3 is a flowchart for describing a login process of a wallet service account according to an embodiment of the present disclosure.

FIG. 4 is a flowchart for describing a creation process of a wallet according to an embodiment of the present disclosure.

FIG. 5 is a flowchart for describing a connection process of an external wallet according to an embodiment of the present disclosure.

FIG. 6 is a flowchart for describing an example of a signature performing process according to an embodiment of the present disclosure.

FIG. 7 is a flowchart for describing another example of a signature performing process according to an embodiment of the present disclosure.

FIG. 8 is a flowchart for describing a login process of a blockchain based external service according to an embodiment of the present disclosure.

FIG. 9 is a flowchart for describing the signature performing process of the blockchain based external service according to an embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, examples of embodiments of the present disclosure will be described in detail with reference to the accompanying drawings. Advantages and features of the present disclosure, and methods for accomplishing the same will be more clearly understood from embodiments described in detail below with reference to the accompanying drawings. However, the present disclosure is not limited to the embodiments set forth below and may be embodied in various different forms. The present embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims. Throughout the whole specification, the same reference numerals denote the same elements.

If there are no other definitions, all the terms used herein (including technical and scientific terms) can be used as a meaning that can be commonly appreciated by those skilled in the art in a technical field to which the present disclosure belongs. In addition, the terms that are commonly used and defined in the dictionary are not ideally or excessively interpreted unless they are clearly defined.

In the present disclosure, the terms “first,” “second,” and the like are used to differentiate one component from other components, but the scope should not be construed to be limited by the terms. For example, the first component may be named the second component, and similarly, the second component may also be named the first component.

In the present disclosure, in each step, reference numerals (e.g., a, b, c, etc.) are used for convenience of description. The reference numerals are not used to describe the order of the steps and unless otherwise stated, it may occur differently from the order specified. That is, the respective steps may be performed similarly to the specified order, performed substantially simultaneously, or performed in an opposite order.

In the present disclosure, expressions such as “have,” “can have,” “include,” or “can include” indicate the presence of the corresponding features (e.g., components such as, numerical value, function, operation, or part), and does not exclude the presence of additional features.

As has been described above, conventional approaches for implementing blockchain wallets for engaging in transactions recorded in a blockchain network use either a centralized wallet or a decentralized wallet. A centralized wallet is a server-side software-based record store implemented by a provider server that maintains the mnemonic or private key (of a public-private key pair) for each user. A decentralized wallet is a client-side software-based record store implemented by a user device that does not store the mnemonic or private key for the user, instead requiring the user to separately maintain their mnemonic or private key. Use of such wallets is required to engage in a blockchain network transaction as records of such transactions, by the very design of blockchain systems, require information that permanently identifies transacting parties, namely, by information associate with their blockchain wallets.

Both the centralized wallet and the decentralized wallet approaches suffer drawbacks due to their technical design and the manners by which they are used within a blockchain network system. In particular, centralized wallets, due to their server-side implementations, are maintained wholly by provider servers and thus are not controllable by individual users thereof. This design limits security over critical wallet information (i.e., the mnemonic and private key) to a provider server, and this security vector is further compromised when an IdP login scheme is enabled for a centralized wallet. Separately, decentralized wallets, due to their client-side implementations, are maintained wholly by user devices and thus controlled by individual users thereof. While this design enables users to secure their wallets on their own, conventional decentralized wallet approaches are susceptible to hacking and like security risks based on network exposures made possible by hot wallet configurations (e.g., during a real-time transaction via which the mnemonic and private key are transmitted external to the user device). Furthermore, even where an external attack does not compromise the security of a decentralized wallet, a user thereof may nevertheless, due to the technical designs thereof imposing client-side maintenance of the mnemonic and private key, irrevocably forfeit the contents of their wallet by the simple act of forgetting or otherwise losing their mnemonic and private key.

Implementations of the present disclosure address technical problems such as these using a decentralized wallet security paradigm that prevents the transmittal of wallet specific information (e.g., a mnemonic or private key) over a network in connection with a real-time blockchain network transaction. In accordance with this decentralized wallet security paradigm, such wallet specific information is encrypted by a client-side encryption operation at a user device using a wallet password that is different from both the mnemonic and the private key. The encrypted wallet specific information is then transmitted over the network to a decentralized wallet service providing apparatus in connection with the real-time blockchain network transaction. Storage of the wallet password is prohibited per the decentralized wallet security paradigm to prevent attacks against same. During a later signature operation to perform with respect to the transaction, the decentralized wallet service providing apparatus transmits the encrypted wallet specific information to the user device, also referred to as a wallet service client, to request user entry of the wallet password for decrypting the encrypted wallet specific information. In response to a successful entry of the wallet password by the user of the wallet service client, the wallet service client uses the decrypted wallet specific information to perform a signature operation for the transaction.

The implementations of the present disclosure accordingly represent both improvements in existing technology related to decentralized wallets of blockchain network systems as well as technical solutions to technical problems fundamentally and necessarily rooted in that technology. That is, the implementations of the present disclosure teach improvements to the functioning of a computer performing the methods disclosed herein, as well as to the technology of decentralized wallets used with blockchain networks and thus to the technological field of blockchain networks themselves by such performance. In particular, the client-side encryption performed in accordance with the present disclosure imposes a new layer of security that prevents malicious attacks to which a blockchain network transaction may otherwise be susceptible when a decentralized wallet is used, without requiring systemic design changes to the blockchain network, a provider server, or the decentralized wallet itself. In one particular example emphasizing these technical solutions, whereas conventional approaches require the transmission of unencrypted mnemonic or private key data, the present disclosure teaches that encrypted wallet specific information associated with a decentralized wallet may be transmitted from a server-side decentralized wallet service providing apparatus to a client-side wallet service client in connection with a signature target message transmitted from the latter to the former for a blockchain network transaction. The decryption process is locally performed at the wallet service client, thereby preventing external exposure of a wallet password used for the decryption process, and resulting in the decrypted wallet specific information becoming available for the wallet service client user to process their subject blockchain network transaction.

Hereinafter, with reference to the accompanying drawings, embodiments of a method for providing a decentralized wallet service, an apparatus for performing the method, and a storage medium for storing a program to execute the method according to the present disclosure will be described in detail.

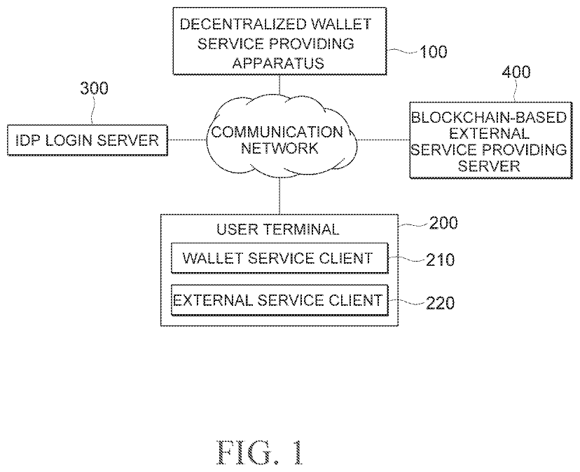

First, a system for providing a decentralized wallet service according to an embodiment of the present disclosure is described with reference to FIG. 1.

FIG. 1 is a block diagram for describing a system for providing a decentralized wallet service according to an embodiment of the present disclosure.

Referring to FIG. 1, the system for providing a decentralized wallet service according to the embodiment of the present disclosure includes a decentralized wallet service providing apparatus 100, a user terminal 200, an IdP login server 300, and a blockchain-based external service providing server 400, which are connected to each other through a communication network, and based thereon, the decentralized integrated wallet service may be provided to a user.

In other words, the decentralized wallet service providing system stores encrypted wallet specific information by using a wallet password to prevent extortion of a private key or a mnemonic in a conventional decentralized wallet, thereby enhancing security. Here, the private key refers to a key that is not disclosed in an asymmetric key pair used in a public key password algorithm, but rather to a key that is private in that it is secretly used.

The decentralized wallet service providing system provides a wallet service account capable of identity provider (IdP) login to allow even general users who are not familiar with a blockchain to conveniently open and manage a wallet, thereby enhancing usability.

The decentralized wallet service providing system provides a decentralized integrated wallet service through the web browser type wallet service client to allow the user to use the wallet service at any time without installing a separate program, thereby enhancing convenience.

The decentralized wallet service providing apparatus 100 communicates with the user terminal 200 to provide the decentralized integrated wallet service to a user with the user terminal 200.

The decentralized wallet service providing apparatus 100 also communicates with the user terminal 200 and the blockchain-based external service providing server 400 to provide the decentralized integrated wallet service to a user using a blockchain-based external service.

The user terminal 200 communicates with the decentralized wallet service providing apparatus 100 and/or the blockchain-based external service providing server 400 by a manipulation of the user to provide the decentralized integrated wallet service.

In this case, the user terminal 200 may provide the decentralized integrated wallet service to the user using a web browser type wallet service client 210 that is executed in the user terminal 200. In addition, the user terminal 200 may provide the blockchain-based external service to the user using a web browser type external service client 220 that is executed in the user terminal 200. That is, the wallet service client 210 and the external service client 220 according to the present disclosure are implemented based on web browsers, not in the form of an extension program installed in a web browser to provide the service through the web browser.

Here, the user terminal 200 may be configured as a terminal that includes a memory means and is equipped with a microprocessor, and has a computation ability, such as not only a desktop computer, but also a notebook computer, a workstation, a palmtop computer, a tablet PC, a personal digital assistant (PDA), a web pad, a smartphone, a mobile phone, etc.

The IdP login server 300 is an apparatus operated by a company that provides an IdP login service and communicates with the decentralized wallet service providing apparatus 100, the user terminal 200, and the blockchain-based external service providing server 400 connected through the communication network to provide the IdP login service.

The blockchain-based external service providing server 400 communicates with the user terminal 200 to provide the blockchain-based external service to the user with the user terminal 200.

The communication network may include a telephone network in addition to data communication networks including a local area network (LAN), a metropolitan area network (MAN), a wide area network (WAN), and the Internet, and may adopt any communication regardless of wired and wireless schemes.

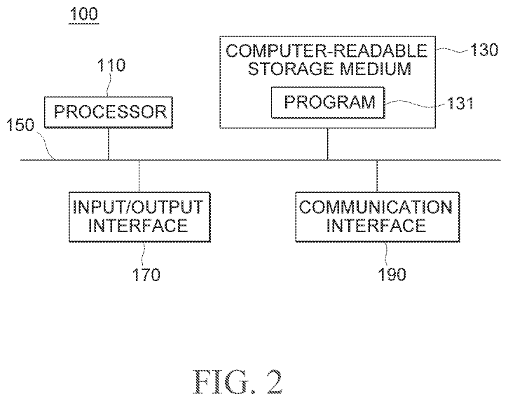

With reference to FIG. 2, the decentralized wallet service providing apparatus according to the embodiment of the present disclosure will be described.

FIG. 2 is a block diagram for describing an apparatus for providing the decentralized wallet service illustrated in FIG. 1.

Referring to FIG. 2, the decentralized wallet service providing apparatus 100 may include one or more processors 110, a computer-readable storage medium 130, and a communication bus 150.

The processor 110 may control the decentralized wallet service providing apparatus 100 to operate. For example, the processor 110 may execute one or more programs 131 stored in the computer-readable storage medium 130. One or more programs 131 may include one or more computer executable instructions, and when the computer executable instruction is executed by the processor 110, the decentralized wallet service providing apparatus 100 may be configured to perform an operation for providing the decentralized wallet service.

The computer-readable storage medium 130 is configured to store the computer executable instruction or program code, program data, and/or other appropriate forms of information for providing the decentralized wallet service. The program 131 stored in the computer-readable storage medium 130 includes a set of the instructions executable by the processor 110. In an embodiment, the computer-readable storage medium 130 may be a memory (a volatile memory such as a random access memory, a non-volatile memory, or an appropriate combination thereof), one or more magnetic disk storage devices, optical disk storage devices, flash memory devices, other types of storage media that may be accessed by the decentralized wallet service providing apparatus 100 or may store desired information, or an appropriate combination thereof.

The communication bus 150 interconnects various other components of the decentralized wallet service providing apparatus 100, including the processor 110 and the computer-readable storage medium 130.

The decentralized wallet service providing apparatus 100 may also include one or more input/output interfaces 170 and one or more communication interfaces 190 for providing an interface for one or more input/output devices. The input/output interface 170 and the communication interface 190 are connected to the communication bus 150. The input/output device (not illustrated) may be connected to other components of the decentralized wallet service providing apparatus 100 through the input/output interface 170.

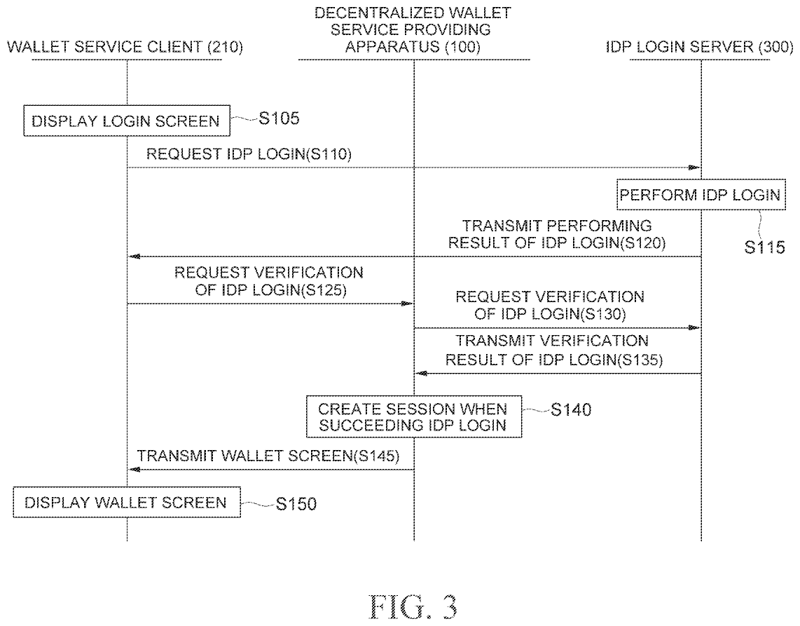

With reference to FIGS. 3 to 9, a method for providing a decentralized wallet service according to an embodiment of the present disclosure will be described.

### Login Process of Wallet Service Account

FIG. 3 is a flowchart for describing a login process of a wallet service account according to an embodiment of the present disclosure.

The processor 110 of the decentralized wallet service providing apparatus 100 may log in to the wallet service account of the user through the IdP login by the manipulation of the user.

In more detail with reference to FIG. 3, the wallet service client 210 may display a login screen according to the manipulation of the user (S105).

Then, the wallet service client 210 may request the IdP login to the IdP login server 300 based on login information (ID, password, etc.) input by the user (S110).

Then, the IdP login server 300 may perform IdP login based on the login information provided by the wallet service client 210 (S115).

Then, the IdP login server 300 may transmit a performing result (success, failure, etc.) of the IdP login to the wallet service client 210 (S120).

Then, the wallet service client 210 may request the verification of the IdP login to the decentralized wallet service providing apparatus 100 based on the login information when the IdP login is made normally (S125).

Then, the processor 110 may request the IdP login verification to the IdP login server 300 based on the login information provided by the wallet service client 210 (S130).

Then, the IdP login server 300 may perform the verification of the IdP login based on the login information provided by the decentralized wallet service providing apparatus 100 and transmit the IdP login verification result to the decentralized wallet service providing apparatus 100 (S135).

Then, when the verification of the IdP login is made normally, the processor 110 may create a session with the wallet service client 210 based on the login information (S140) and transmits a wallet screen to the wallet service client 210 (S145).

Then, the wallet service client 210 displays the wallet screen received from the decentralized wallet service providing apparatus 100 to complete the login of the wallet service account (S150).

Of course, when the user does not have the wallet service account for the use of the decentralized integrated wallet service, the wallet service client 210 may create the wallet service account of the user through the IdP login according to the manipulation of the user.

### Creation Process of Wallet

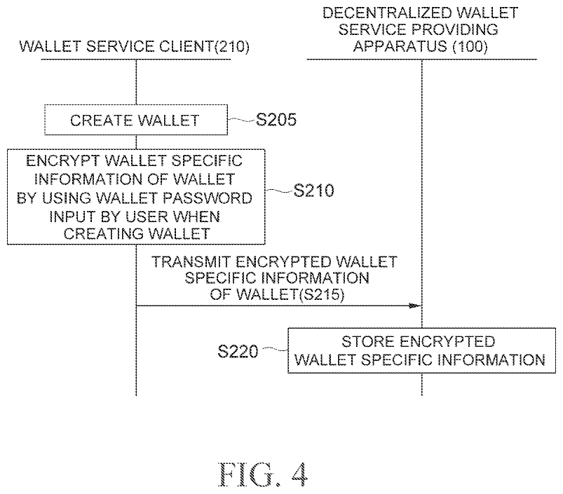

FIG. 4 is a flowchart for describing a creation process of a wallet according to an embodiment of the present disclosure.

Referring to FIG. 4, the wallet service client 210 may create a wallet by the manipulation of the user (S205).

In other words, the wallet service client 210 may create a new wallet in the wallet service account by the manipulation of the user that logs in to the wallet service account.

In this case, the user may input a wallet password used for protection of the created wallet. The wallet password, as information used to encrypt wallet-specific information in the wallet service to protect each wallet connected to the wallet service account by the user, may include characters, numbers, symbols, etc.

In addition, the wallet password may be set to correspond to the user's wallet service account by the user to be used for all of the wallets connected to the user's wallet service account, or set for each wallet by the user.

Then, the wallet service client 210 may encrypt the wallet specific information of the wallet using the wallet password input by the user when creating the wallet (S210).

In other words, the wallet service client 210 may encrypt the wallet specific information, which is information that should be known by only the user, among the private key, the public key, a wallet address, mnemonic, etc. acquired as the wallet is created, by using the wallet password. The wallet specific information refers to the private key or mnemonic.

Then, the wallet service client 210 may transmit the encrypted wallet specific information of the wallet to the decentralized wallet service providing apparatus 100 (S215).

In this case, the wallet service client 210 may not store the encrypted wallet specific information using the wallet password.

Then, the processor 110 of the decentralized wallet service providing apparatus 100 may store the encrypted wallet specific information (S220).

As such, when the wallet is created, the wallet specific information (private key or mnemonic) itself, which is the information that should be known by only the user of the wallet, is not stored anywhere in the user terminal 200 or the decentralized wallet service providing apparatus 100, but the wallet specific information (private key or mnemonic) encrypted by using the wallet password input by the user when the wallet is created may be stored only in the decentralized wallet service providing apparatus 100 and used for a signature operation afterwards. At this time, the wallet password is not also stored anywhere in the user terminal 200 or the decentralized wallet service providing apparatus 100 and is known by only the user of the wallet. This storage limitation prevents external exposure of the wallet specific information by preventing the wallet specific information from being accessible to external actors in an unencrypted format. Accordingly, the present disclosure may provide a decentralized wallet service that does not control the wallet in the center.

### Connection Process of External Wallet

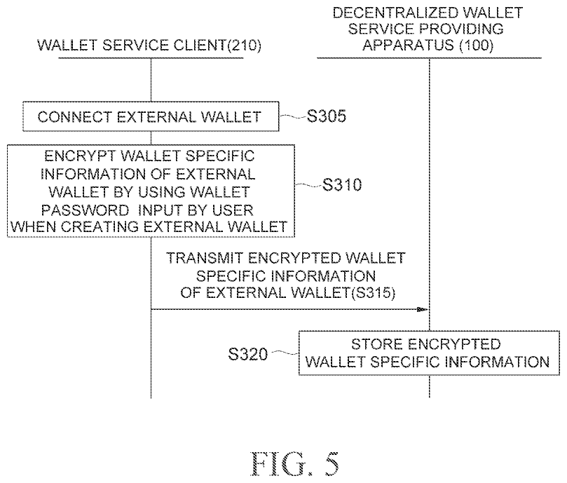

FIG. 5 is a flowchart for describing a connection process of an external wallet according to an embodiment of the present disclosure.

The processor 110 of the decentralized wallet service providing apparatus 100 may connect an external wallet to the wallet service account when receiving a connection request of the external wallet from the web browser type wallet service client 210.

In more detail by referring to FIG. 5, the wallet service client 210 may connect the external wallet created through an external service by the manipulation of the user (S305).

In other words, the wallet service client 210 may connect the external wallet of the user created through the external service to the wallet service account based on the information (private key, public key, wallet address, mnemonic, etc.) input by the manipulation of the user who logs to the wallet service account.

In this case, the user may input the wallet password used for the protection of the connected external wallet.

Then, the wallet service client 210 may encrypt the wallet specific information of the external wallet using the wallet password input by the user when connecting the external wallet (S310).

Then, the wallet service client 210 may transmit the encrypted wallet specific information of the external wallet to the decentralized wallet service providing apparatus 100 (S315).

In this case, the wallet service client 210 may not store the encrypted wallet specific information using the wallet password.

Then, the processor 110 may store the encrypted wallet specific information (S320).

As such, when the external wallet created through another wallet service is connected, the wallet specific information (private key or mnemonic) itself, which is the information that should be known by only the user of the external wallet, is not stored anywhere in the user terminal 200 or the decentralized wallet service providing apparatus 100, but the wallet specific information (private key or mnemonic) encrypted by using the wallet password input by the user when the external wallet is connected may be stored only in the decentralized wallet service providing apparatus 100 and used for the signature operation afterwards. At this time, the wallet password is not also stored anywhere in the user terminal 200 or the decentralized wallet service providing apparatus 100 and is known by only the user of the external wallet. As stated above, this storage limitation prevents external exposure of the wallet specific information by preventing the wallet specific information from being accessible to external actors in an unencrypted format.

### Example of Signature Performing Process

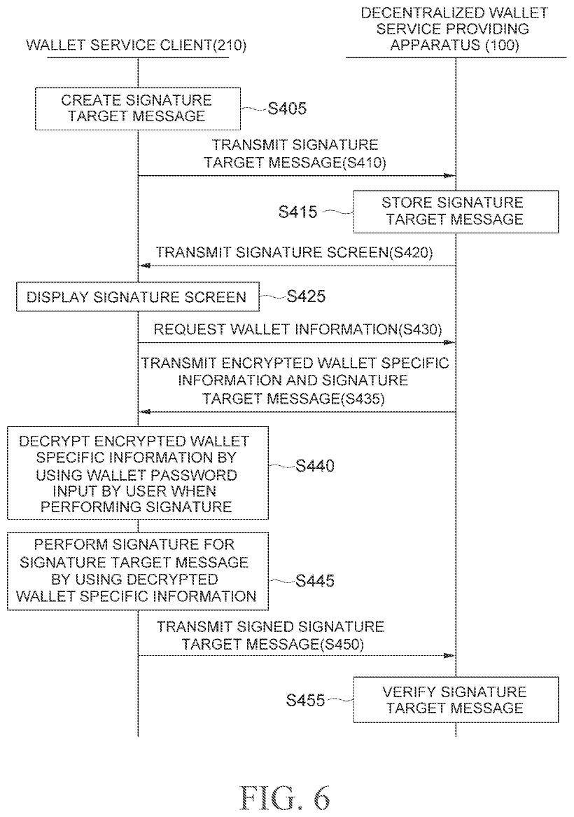

FIG. 6 is a flowchart for describing an example of a signature performing process according to an embodiment of the present disclosure.

The processor 110 of the decentralized wallet service providing apparatus 100 may perform the signature by using the stored encrypted wallet specific information when receiving a signature target message according to the wallet service from the web browser type wallet service client 210.

In more detail by referring to FIG. 6, the wallet service client 210 may create the signature target message when a work that requires the signature is generated by the manipulation of the user (S405).

Here, the signature target message may be a transaction message created by the wallet service client 210 based on the manipulation of the user. For example, the transaction message may be a message related to NFT transmission and token remittance.

Then, the wallet service client 210 may transmit the signature target message to the decentralized wallet service providing apparatus 100 (S410).

Then, the processor 110 may store the signature target message received from the wallet service client 210 (S415).

Then, the processor 110 may transmit a signature screen to the wallet service client 210 (S420).

Then, the wallet service client 210 may display the signature screen received from the decentralized wallet service providing apparatus 100 (S425).

Then, the wallet service client 210 may request wallet information to the decentralized wallet service providing apparatus 100 (S430).

Then, the processor 110 may transmit the stored encrypted wallet specific information and the stored signature target message to the wallet service client 210 (S435).

Then, the wallet service client 210 may decrypt the encrypted wallet specific information using the wallet password input by the user during signing (S440).

Then, the wallet service client 210 may sign the signature target message by using the decrypted wallet specific information (S445).

Then, the wallet service client 210 may transmit the signed signature target message to the decentralized wallet service providing apparatus 100 (S450).

Then, the processor 110 may verify the signed signature target message (S455). In other words, the processor 110 may check whether the signature target message is falsified by comparing the stored signature target message and the signature target message for which the signature is performed.

Then, when an operation after the signature performing operation is required according to the signature target message, the processor 110 may perform the operation. For example, when the signature target message is the transaction message related to the NFT transmission, token remittance, etc., the processor 110 may transmit a transaction message signed by the blockchain and transmit a transmission result to the wallet service client 210.

As such, in the present disclosure, the decryption of the wallet specific information is not performed by the decentralized wallet service providing apparatus 100, which is the server, and the wallet specific information encrypted with the wallet password is delivered to the web browser type wallet service client 210, which is the client, so the web browser type wallet service client 210 may conduct decryption and signature by using the wallet password input by the user. Accordingly, the present disclosure may provide a decentralized wallet service that does not control the wallet in the center. In addition, in the present disclosure, it is possible to decrypt the wallet specific information and sign the message only with a volatile wallet password input by the user. On the other hand, the conventional blockchain wallets are installed as an extension program in the web browser, which is the client, so if the wallet is not logged out when the wallet is not used, there is a problem of exposing the wallet when another user executes the web browser. In addition, although the information of the wallet is encrypted and stored inside the extension program, it is possible to extort the information of the wallet through decryption through indiscriminate assignment, so there is a problem in that it is vulnerable in terms of security.

### Another Example of Signature Performing Process

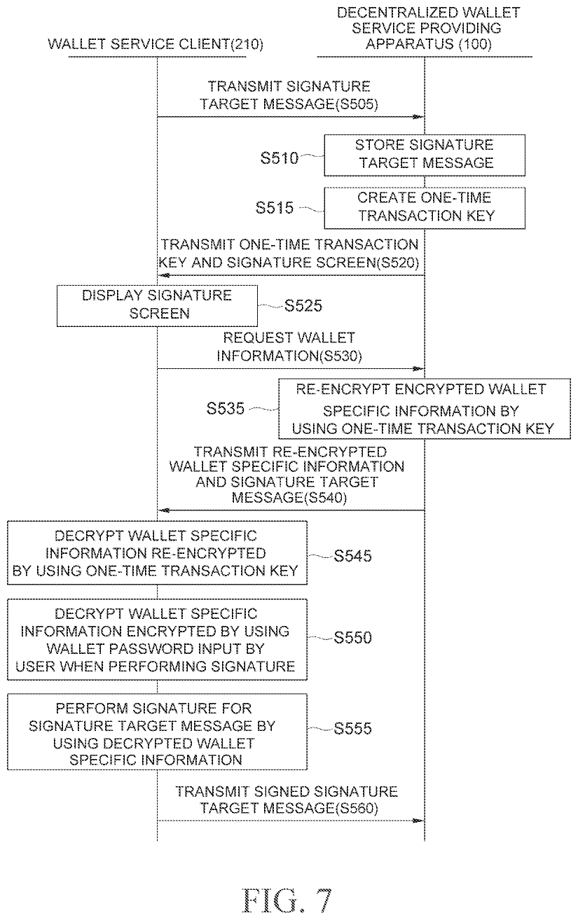

FIG. 7 is a flowchart for describing another example of a signature performing process according to an embodiment of the present disclosure.

The processor 110 of the decentralized wallet service providing apparatus 100 may perform the signature by strengthening security using an additional one-time transaction key based on an example of the signature performing process illustrated in FIG. 6.

In more detail by referring to FIG. 7, the wallet service client 210 may transmit the signature target message to the decentralized wallet service providing apparatus 100 (S505).

Then, the processor 110 may store the signature target message received from the wallet service client 210 (S510).

Then, the processor 110 may create a one-time transaction key (S515). Here, the one-time transaction key refers to a key that is valid only for the signing process of the current signature target message.

Then, the processor 110 may transmit the one-time transaction key and the signature screen to the wallet service client 210 (S520).

Then, the wallet service client 210 may display the signature screen received from the decentralized wallet service providing apparatus 100 (S525).

Then, the wallet service client 210 may request wallet information to the decentralized wallet service providing apparatus 100 (S530).

Then, the processor 110 may re-encrypt the stored encrypted wallet specific information using the one-time transaction key (S535).

Then, the processor 110 may transmit the re-encrypted wallet specific information and the stored signature target message to the wallet service client 210 (S540).

Then, the wallet service client 210 may decrypt the re-encrypted wallet specific information by using the one-time transaction key received from the decentralized wallet service providing apparatus 100 (S545).

Then, the wallet service client 210 may decrypt the encrypted wallet specific information using the wallet password input by the user during signing (S550).

Then, the wallet service client 210 may sign the signature target message by using the decrypted wallet specific information. (S555).

Then, the wallet service client 210 may transmit the signed signature target message to the decentralized wallet service providing apparatus 100 (S560).

Then, the processor 110 may verify the signed signature target message. Then, when an operation after the signature performing operation is required according to the signature target message, the processor 110 may perform the operation. For example, when the signature target message is the transaction message related to the NFT transmission, token remittance, etc., the processor 110 may transmit a transaction message signed by the blockchain and transmit a transmission result to the wallet service client 210.

### Login Process of Blockchain-Based External Service

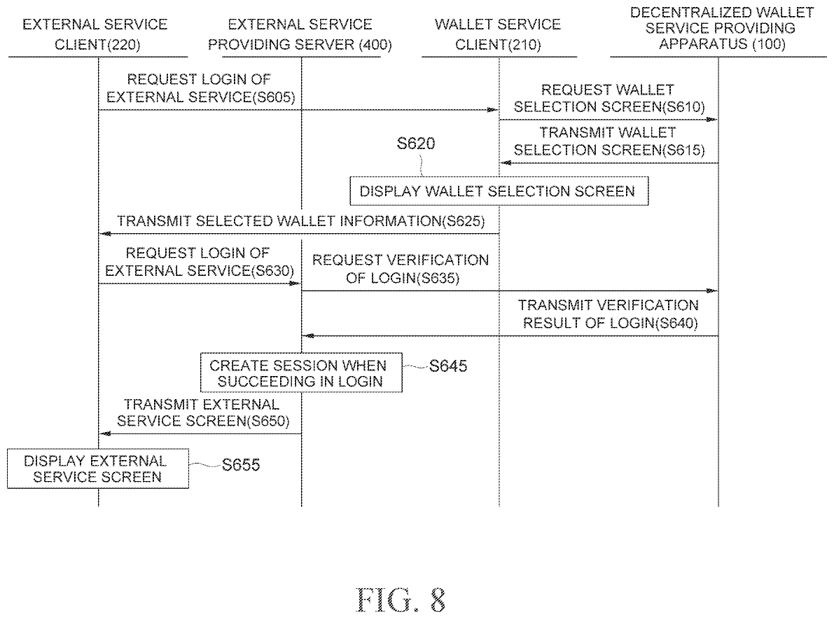

FIG. 8 is a flowchart for describing a login process of a blockchain based external service according to an embodiment of the present disclosure.

When the processor 110 of the decentralized wallet service providing apparatus 100 receives a login request of the blockchain-based external service from the blockchain-based external service providing server 400, the processor 110 may perform the login of the blockchain-based external service by using one wallet selected by the user among wallets connected to the wallet service account.

In more detail by referring to FIG. 8, the external service client 220 may request the login of the blockchain-based external service to the wallet service client 210 according to the manipulation of the user (S605).

Then, the wallet service client 210 may be created in the form of a child-window of the external service client 220 and may start the operation for performing the login of the blockchain-based external service using the wallet. In this case, if the user's wallet service account is not logged in, the wallet service client 210 may first perform the login process of the wallet service account illustrated in FIG. 3.

Then, the wallet service client 210 may request a wallet selection screen to the decentralized wallet service providing apparatus 100 (S610).

Then, the processor 110 may transmit a wallet selection screen containing information (wallet addresses) of the wallet connected to the user's wallet service account to the wallet service client 210 (S615).

Then, the wallet service client 210 may display the wallet selection screen received from the decentralized wallet service providing apparatus 100 (S620).

Then, when one wallet is selected by the user's manipulation from the wallet connected to the user's wallet service account, the wallet service client 210 may transmit information on the selected wallet to the external service client 220 (S625).

Then, the external service client 220 may transmit the information on the selected wallet and request the login of the blockchain-based external service to the blockchain-based external service providing server 400 (S630).

Then, the blockchain-based external service providing server 400 may request the verification of the login to the decentralized wallet service providing apparatus 100 based on the information received from the external service client 220 (S635). For example, the blockchain-based external service providing server 400 may obtain account information corresponding to the information received from the external service client 220 based on the stored account information, transmit the obtained account information, and request the login verification to the decentralized wallet service providing apparatus 100. Here, the account information is information about an account using the blockchain-based external service, and may include, if the account of the blockchain-based external service is linked to one wallet connected to the wallet service account, the information (wallet address, user information, etc.) received from the decentralized wallet service providing apparatus 100 when linking the wallet.

Then, the processor 110 may perform the verification of the login based on the information received from the blockchain-based external service providing server 400 and transmit the verification result of the login to the blockchain-based external service providing server 400 (S640).

Then, when the verification of the login is made normally, the blockchain-based external service providing server 400 may create a session with the external service client 220 based on the login information (S645) and transmit a blockchain-based external service screen to the external service client 220 (S650).

Then, the external service client 220 may display the blockchain-based external service screen received from the blockchain-based external service providing server 400 to complete the login of the blockchain-based external service (S655).

Of course, when the user wants to create the account of the blockchain-based external service using one wallet connected to the wallet service account, the external service client 220 interlocks with the wallet service client 210, etc. to create the account of the blockchain-based external service using one wallet connected to the wallet service account according to the manipulation of the user.

As such, the wallet connected to the wallet service account may be matched with one user account in the blockchain-based external service. Accordingly, in the present disclosure, the wallet service may be conveniently and easily linked with various blockchain-based external services by the unit of the wallet.

### Signature Performing Process of Blockchain-Based External Service

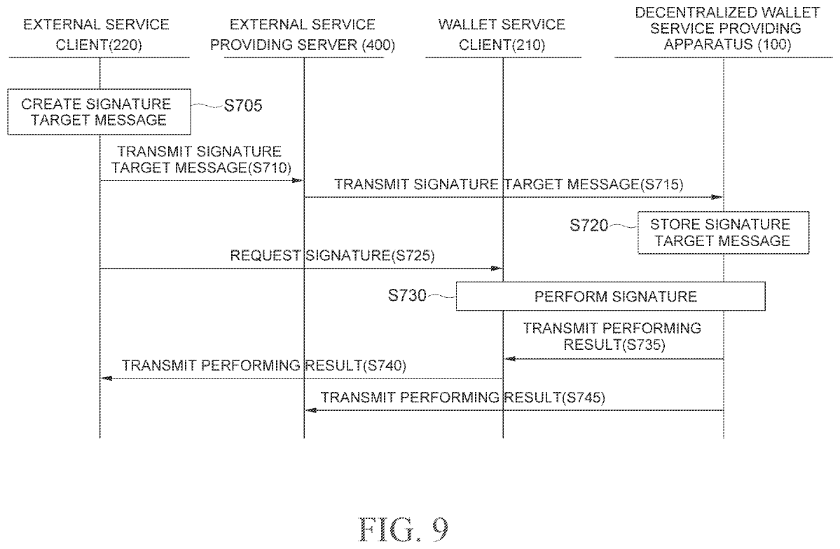

FIG. 9 is a flowchart for describing the signature performing process of the blockchain based external service according to an embodiment of the present disclosure.

When the processor 110 of the decentralized wallet service providing apparatus 100 receives the signature target message according to the external service from the blockchain-based external service providing server 400, the processor 110 may perform the signature by using the stored encrypted wallet specific information.

In more detail by referring to FIG. 9, the external service client 220 may create the signature target message when a work that requires the signature is generated by the manipulation of the user (S705).

Here, the signature target message may be a transaction message created by the external service client 220 based on the manipulation of the user. For example, the transaction message may be a message related to the NFT transmission and the token remittance.

Then, the external service client 220 may transmit the signature target message to the blockchain-based external service providing server 400 (S710).

Then, the blockchain-based external service providing server 400 may transmit the signature target message to the decentralized wallet service providing apparatus 100 (S715).

Then, the processor 110 may store the signature target message received from the blockchain-based external service providing server 400 (S720).

Thereafter, the external service client 220 may request the signature to the wallet service client 210 (S725).

Then, the wallet service client 210 may be created in the form of the child-window of the external service client 220 and may start the operation for performing the signature. That is, the wallet service client 210 may perform the signature performing process illustrated in FIG. 6 or 7 (S730). In this case, if the user's wallet service account is not logged in, the wallet service client 210 may first perform the login process of the wallet service account illustrated in FIG. 3.

Then, the processor 110 may transmit a signature performing result (success, failure, etc.) to the wallet service client 210 (S735). Then, the wallet service client 210 may transmit the signature performing result to the external service client 220 (S740). In addition, the processor 110 may transmit the signature performing result to the blockchain-based external service providing server 400 (S745).

Then, when an operation after the signature performing operation is required according to the signature target message, the processor 110 may perform the operation. For example, when the signature target message is the transaction message related to the NFT transmission, token remittance, etc., the processor 110 may transmit a transaction message signed by the blockchain and transmit a transmission result to the wallet service client 210 and the blockchain-based external service providing server 400.

The operations according to the embodiments are implemented in a form of a program command that may be performed through various computer means and may be recorded in a computer readable storage medium. The computer readable storage medium represents any medium that participates in providing instructions to a processor for execution. The computer readable storage medium may include a program command, a data file, a data structure or a combination thereof. For example, the computer readable storage medium may include a magnetic medium, an optical storage medium, a memory, and the like. A computer program may be distributed on a networked computer system so that a computer readable code may be stored and executed in a distributed manner. Functional programs, codes, and code segments for implementing the embodiment may be easily inferred by programmers in the art to which the embodiment belongs.

The embodiments are for describing the technical spirit of this disclosure, and the scope of the technical spirit of this disclosure is not limited by the embodiments described herein. The protection scope of this disclosure should be interpreted by the appended claims and all technical spirit in the equivalent range thereto should be interpreted to be embraced by the claims of this disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for providing a decentralized wallet service, the method comprising:
receiving, from a user terminal, wallet specific information encrypted by using a wallet password input when a wallet is created by a user; and
storing the wallet specific information encrypted by using the wallet password,
wherein the wallet specific information encrypted by using the wallet password is not stored in the user terminal.

2. The method of claim 1, wherein the user terminal is a web browser type wallet service client executed by the user terminal.

3. The method of claim 2, further comprising:
logging in to a wallet service account of the user through identity provider (IdP) log by a manipulation of the user,
wherein in the receiving of the wallet specific information, the wallet specific information encrypted by using the wallet password input by the user who logs in to the wallet service account is received from the web browser type wallet service client.

4. The method of claim 3, further comprising:
when a signature target message according to a wallet service is received from the web browser type wallet service client, performing the signature by using the stored encrypted wallet specific information.

5. The method of claim 4, wherein the performing of the signature includes
when the signature target message is received from the web browser type wallet service client, storing the signature target message as signed;
when a wallet information request is received from the web browser type wallet service client, transmitting the stored encrypted wallet specific information and the stored signature target message to the web browser type wallet service client; and
receiving, from the web browser type wallet service client, the signature target message signed based on the wallet specific information decrypted from the wallet specific information encrypted by using the wallet password input when performing the signature by the user.

6. The method of claim 5, wherein in the storing of the signature target message, the signature target message as signed is stored, and a one-time transaction key is transmitted to the web browser type wallet service client,
in the transmitting of the encrypted wallet specific information, the encrypted wallet specific information is re-encrypted by using the one-time transaction key, and the re-encrypted wallet specific information and the signature target message are transmitted to the web browser type wallet service client, and
in the receiving of the signature target message as signed, the re-encrypted wallet specific information is decrypted by using the one-time transaction key, and then the signature target message signed based on the wallet specific information decrypted from the wallet specific information encrypted by using the wallet password input is received from the web browser type wallet service client when performing the signature by the user.

7. The method of claim 4, wherein the signature target message is a transaction message created by the web browser type wallet service client.

8. The method of claim 4, further comprising:
when a connection request of an external wallet is received from the web browser type wallet service client, connecting the external wallet to the wallet service account.

9. The method of claim 8, wherein the connecting of the external wallet includes
receiving the encrypted wallet specific information of the external wallet by using the wallet password input when connecting the external wallet by the user from the web browser type wallet service client; and
storing the encrypted wallet specific information of the external wallet, and
the encrypted wallet specific information of the external wallet is not stored in the web browser type wallet service client.

10. The method of claim 4, further comprising:
when a login request of a blockchain-based external service is received from a blockchain-based external service providing server, performing the login of the blockchain-based external service by using a wallet selected by the user among the wallets connected to the wallet service account.

11. The method of claim 10, further comprising:
when a signature target message according to an external service is received from the blockchain-based external service providing server, performing the signature by using the stored encrypted wallet specific information.

12. The method of claim 11, wherein the performing of the signature includes
When the signature target message is received from the blockchain-based external service providing server, storing the signature target message as received;
when a wallet information request is received from a web browser type external service client executed by the user terminal through the web browser type wallet service client, transmitting the stored encrypted wallet specific information and the signature target message as stored to the web browser type wallet service client; and
receiving, from the web browser type wallet service client, the signature target message signed based on the wallet specific information decrypted from the wallet specific information encrypted by using the wallet password input when performing the signature by the user.

13. The method of claim 12, wherein in the storing of the signature target message, the signature target message as received is stored, and a one-time transaction key is transmitted to the blockchain-based external service providing server,
in the transmitting of the encrypted wallet specific information, the encrypted wallet specific information is re-encrypted by using the one-time transaction key, and the re-encrypted wallet specific information and the signature target message are transmitted to the web browser type wallet service client, and
in the receiving of the signature target message as signed, the re-encrypted wallet specific information is decrypted by using the one-time transaction key provided from the web browser type external service client, and then the signature target message signed based on the wallet specific information decrypted from the wallet specific information encrypted by using the wallet password input is received from the web browser type wallet service client when performing the signature by the user.

14. The method of claim 11, wherein the signature target message is a transaction message created by a web browser type external service client.

15. The method of claim 4, wherein the wallet password is set to correspond to the wallet service account by the user to be used for all of the wallets connected to the wallet service account, or set for each wallet by the user.

16. The method of claim 4, wherein the wallet specific information is a private key or mnemonic.

17. A computer-readable storage medium having a program for executing for a method for providing a decentralized wallet service disclosed in claim 1 in a computer, which is recorded therein.

18. An apparatus for providing a decentralized wallet service, the apparatus comprising:
a memory storing one or more programs for providing a decentralized wallet service; and
one or more processors performing an operation for providing the decentralized wallet service according to the one or more programs stored in the memory,
wherein the processor receives, from a user terminal, wallet specific information encrypted by using a wallet password input when creating a wallet by a user, and stores the wallet specific information encrypted by using the wallet password, and
the wallet specific information encrypted by using the wallet password is not stored in the user terminal.

19. The apparatus of claim 18, wherein the user terminal is a web browser type wallet service client executed by the user terminal.

20. The apparatus of claim 19, wherein the processor logs in to a wallet service account of the user through identity provider (IdP) log by a manipulation of the user, and
receives the wallet specific information encrypted by using the wallet password input by the user who logs in to the wallet service account from the web browser type wallet service client.
